(19) United States
(12) Patent Application Publication
(10) Pub. No.: US 2003/0067136 A1
(43) Pub. Date: Apr. 10, 2003

(54) Air spring trailer suspension

(76) Inventors: Michael Charles Scott, Aldergrove (CA); Donald Barry Fergusson, Aldergrove (CA)

Correspondence Address: NORMAN M. CAMERON, SUITE 1401 - 1166 ALBERNI STREET, VANCOUVER, BC, V6E 3Z3, CA

(21) Appl. No.: 09/971,599

(22) Filed: Oct. 9, 2001

(51) Int. Cl. B60G 9/04; B60P 1/00

(52) U.S. Cl. 280/124.157; 280/5.514

(57) ABSTRACT

A vehicle trailer has a rear end and an air spring suspension. The trailer includes a body, an axle and a pair of wheels mounted on the axle. A pair of air springs extends operatively between the axle and the body. The air springs have sufficient extensibility to allow the body to be raised or lowered with respect to the wheels and to tip downwardly toward the rear end of the trailer to load the trailer. Preferably the trailer has two axles, each said axle having a pair of wheels mounted thereon and a pair of air springs extending between each axle and the body. Preferably there is an air compressor operatively connected to the air springs. The trailer may include a pair of trailing arms pivotally connected to the body adjacent to each axle. The trailing arms are on opposite sides of the body. The air springs are connected between the trailing arms and the body. Preferably there is a multiposition valve connected between the compressor and the air springs to control ride height and tipping of the body.

### BACKGROUND OF THE INVENTION

This invention relates to trailers and, in particular, to vehicle trailers having air spring suspensions and more particularly to trailers having adjustable ride heights and tilting functions.

The use of air springs in trailing arm suspensions is known in earlier references such as U.S. Pat. No. 5,639,110 and PCT Patent Application No. PCT/SE91/00566. The concept of using airbags with trailing arms on mobile axle trailers is also known, as seen, for example, in U.S. Pat. No. 4,934,733.

U.S. Pat. No. 5,667,231 shows a trailer which kneels at the back. This is not accomplished by air springs alone, but rather uses a hydraulic cylinder near the hitch. The suspension utilizes airbags and trailing arms on a dual axle vehicle.

PCT Patent Application No. PCT/GB89/00465 discloses the concept of mounting the suspension below a high portion of a frame. Also U.S. Pat. No. 5,810,377 shows an axle which is lower at the middle compared to the height of the centers of the wheels.

However, the prior art does not reveal a highly adaptable, multifunction air spring suspension for lighter gross vehicle weight trailers such as boat trailers and horse trailers.

It is an object of the invention to provide an improved air spring trailer suspension which is simple and reliable, but at the same time capable of maintaining the ride height of the trailer.

It is also an object of the invention to provide an improved air spring trailer suspension which is capable of raising or lowering the trailer to adjust the ride height as desired.

It is a further object of the invention to provide an improved air spring trailer suspension which is capable of tilting the trailer downwards toward the rear end thereof for loading purposes.

### SUMMARY OF THE INVENTION

There is provided, according to an embodiment of the invention, a vehicle trailer having a rear end and an air spring suspension. The trailer includes a body, an axle and a pair of wheels mounted on the axle. A pair of air springs extend between the axle and the body. The air springs have sufficient extensibility to allow the body to be raised or lowered with respect to the wheels and to be tipped downwardly toward the rear end of the trailer to load the trailer. In one example the trailer has two axles, each axle having a pair of wheels mounted thereon and a pair of air springs extending between each axle and the body.

Preferably there is an air compressor operatively connected to the air springs. There may also be a ride height sensor connected to the trailer to turn the compressor on or off to maintain a ride height for the trailer.

The trailer may include a pair of trailing arms pivotally connected to the body adjacent to each axle. The trailing arms are on opposite sides of the body. The air springs are connected between the trailing arms and the body.

Preferably there is a multiposition valve connected between the compressor and the air springs to control ride height and tipping of the body.

The invention provides significant improvements compared with the prior art. By providing air springs which are sufficiently extensible, together with an associated pneumatic control system, the invention allows a relatively simple and inexpensive air spring suspension to fulfill multiple roles including maintaining ride height of the trailer and allowing the overall ride height to be raised or lowered as desired according to the hitch height of the towing vehicle or the condition of the surrounding terrain. Also, it allows the trailer to be tipped rearwardly for loading purposes without requiring additional components such as pneumatic cylinders as found in the prior art.

### BRIEF DESCRIPTION OF THE DRAWINGS

Referring to the drawings:

FIG. 1 is a simplified, side elevational view of a trailer according to an embodiment of the invention shown connected to the rear of a vehicle shown in fragment, the trailer being shown at a normal ride height;

FIG. 2 is a view similar to FIG. 1 showing the trailer at a raised ride height;

FIG. 3 is a side elevational view of the trailer and vehicle fragment of FIGS. 1 and 2, the trailer being tipped rearwardly for loading purposes;

FIG. 4 is a simplified, side elevation of the trailing arms, air springs and a fragment of the frame of the trailer of FIGS. 1-3, the trailing arms being mounted on a raised portion of the frame;

FIG. 5 is a view similar to FIG. 4, showing a variation where the raised portion of the frame continues to the back end of the trailer;

FIG. 6 is a view similar to FIG. 4, showing a variation where the frame has no raised portion;

FIG. 6A is a view similar to FIG. 4, showing a variation with a double kick-up frame;

FIG. 7 is an isometric view of one of the trailing arms of FIGS. 4-6;

FIG. 8 is a top plan view of the trailing arm of FIG. 7;

FIG. 9 is an isometric view showing a fragment of the frame of FIG. 4 and of the brackets for mounting one of the trailing arms thereof;

FIG. 10 is an exploded front view of an outer fragment of one of the axles of FIG. 4, showing an air spring and one of the wheels of the trailer;

FIG. 11 is a diagrammatic view of the hydraulic components for the trailer of FIGS. 1-3;

FIG. 12 is a series of diagrams illustrating different positions of a four port multiposition valve thereof; and

FIG. 13 is a view similar to FIG. 12 showing an alternative six port multiposition valve.

### DETAILED DESCRIPTION OF THE PREFERRED EMBODIMENTS

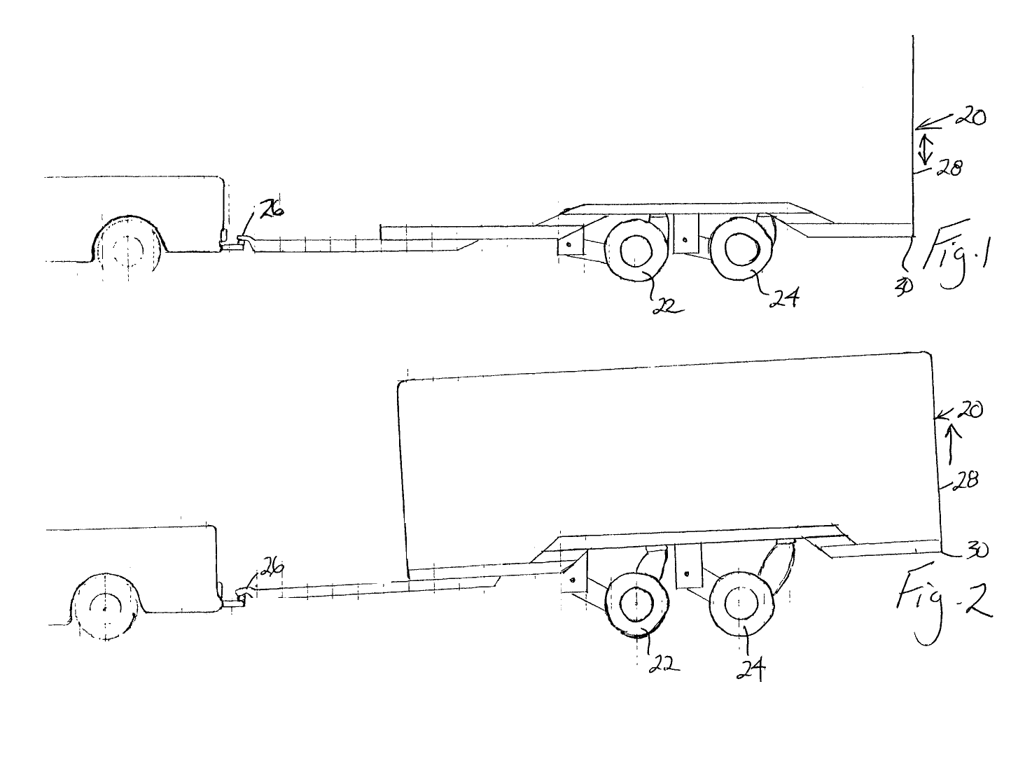

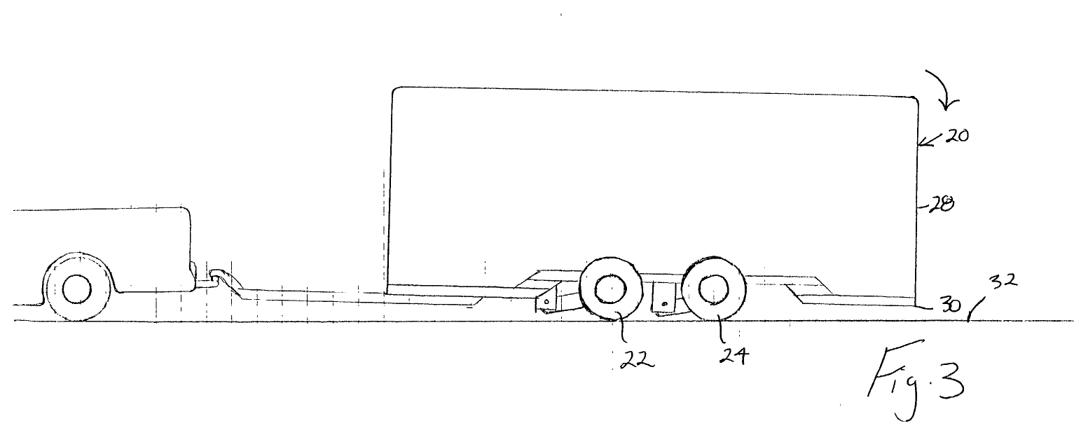

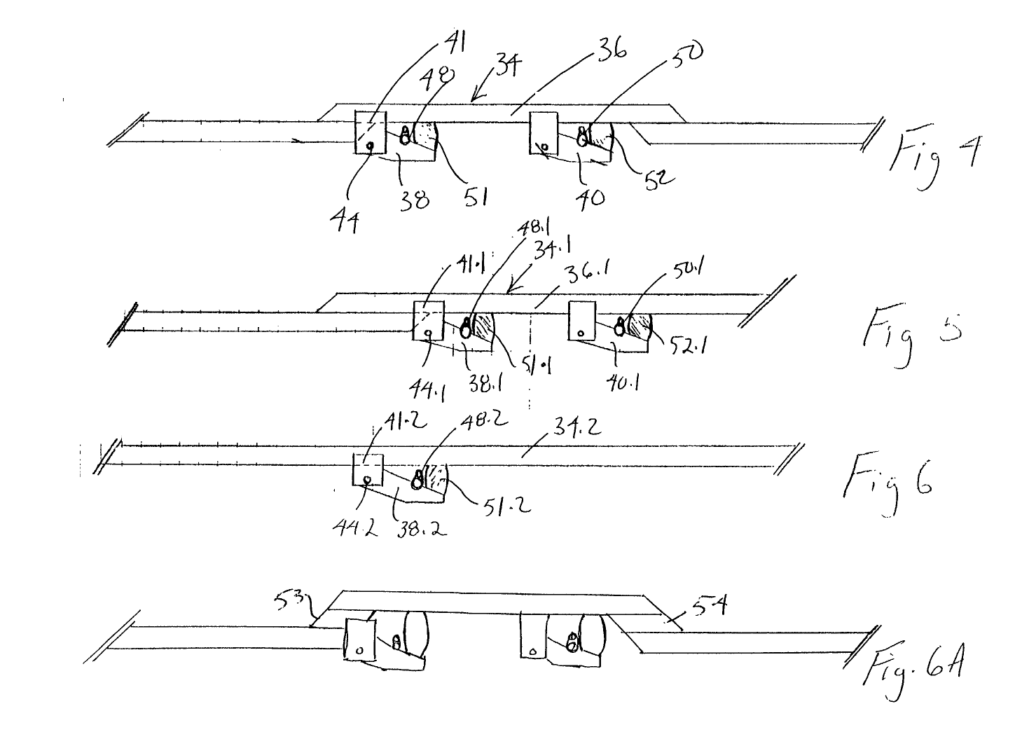

Referring to the drawings, and first to FIGS. 1-3, these show a trailer 20 according to an embodiment of the invention. FIG. 1 shows the trailer in the normal, level travel position. FIG. 2 shows the trailer 20 in a raised position relative to wheels 22 and 24. The trailer can be raised as shown for use over rough terrain. The trailer 20 is a horse trailer, but the invention is applicable to other types of trailers, specifically low gross vehicle weight (GVW) trailers such as R.V. or utility trailers. FIG. 3 shows the capability of trailer 20 to tip downwardly toward rear end 28 thereof for loading or unloading purposes such that edge 30 of the body, adjacent the rear end, is on ground 32 or near the ground.

FIG. 4 shows a fragment of frame 34 of the trailer 20 which includes a raised portion 36 above the wheels 22 and 24 shown in FIGS. 1-3. The trailer has a suspension comprising a pair of trailing arms 38 and 40 on each side of the trailer. Each of the trailing arms is connected to a pair of spaced apart brackets 41 and 42, shown better in FIG. 9, by means of a pin 44 as shown for arm 38. The wheels are mounted on a pair of axles 48 and 50 which are mounted on the trailing arms. Air springs 51 and 52 extend operatively between the axles and the body and are mounted on the trailing arms and the frame respectively. FIG. 6A shows a variation of the version of FIG. 4 with a double raised frame section including spacer tubes 53 and 54.

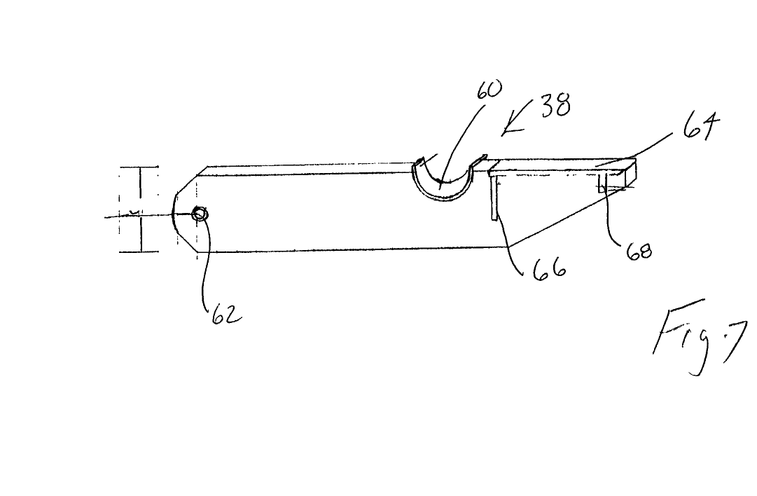

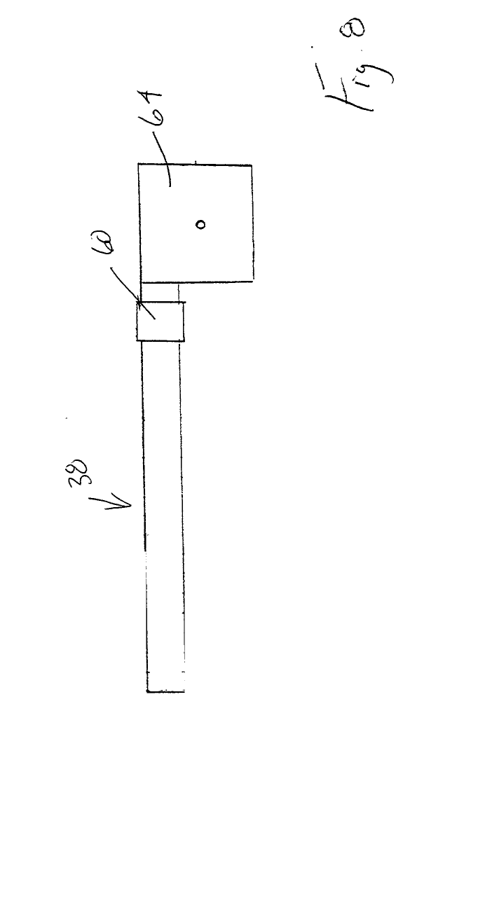

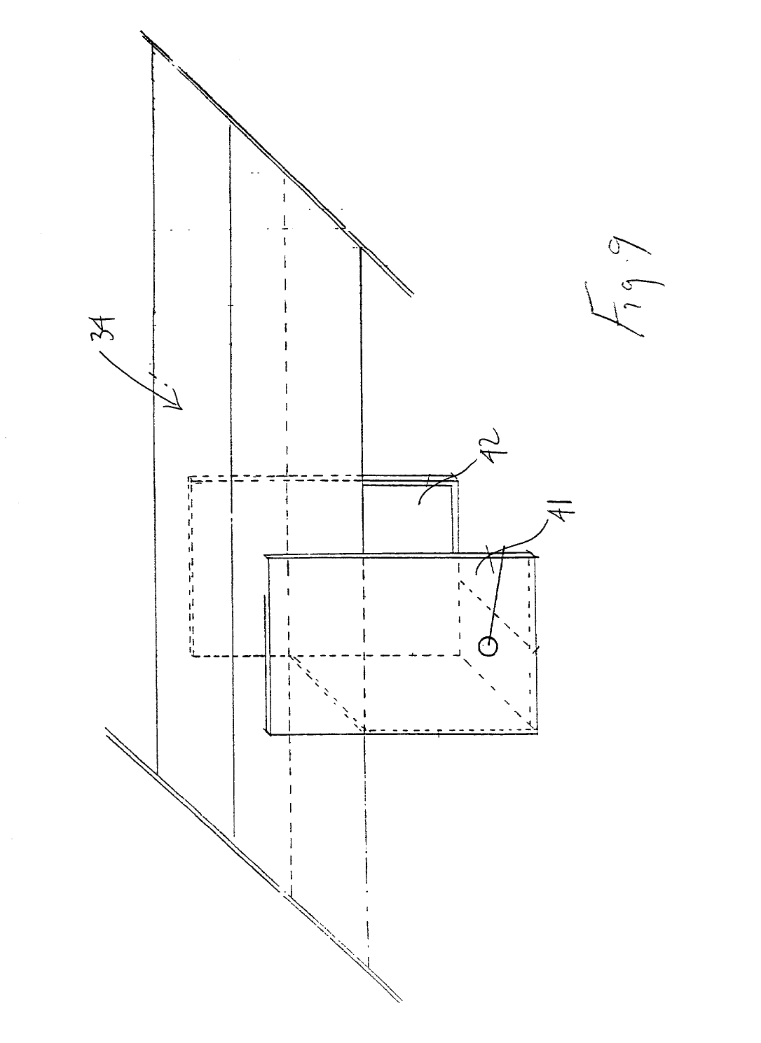

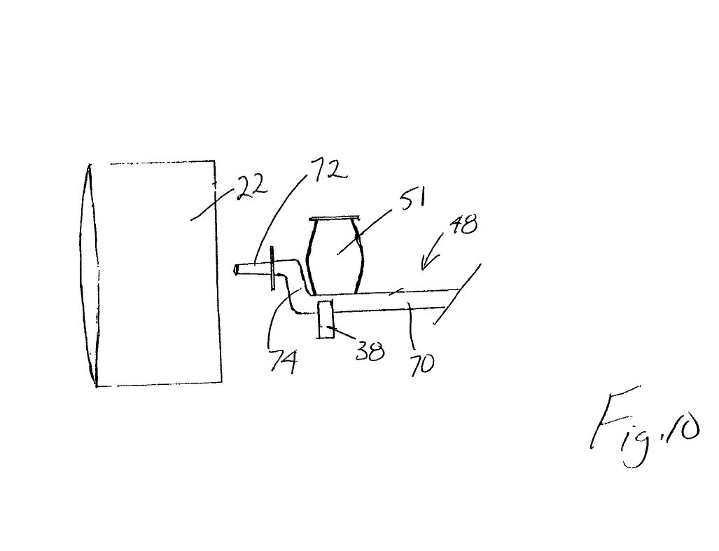

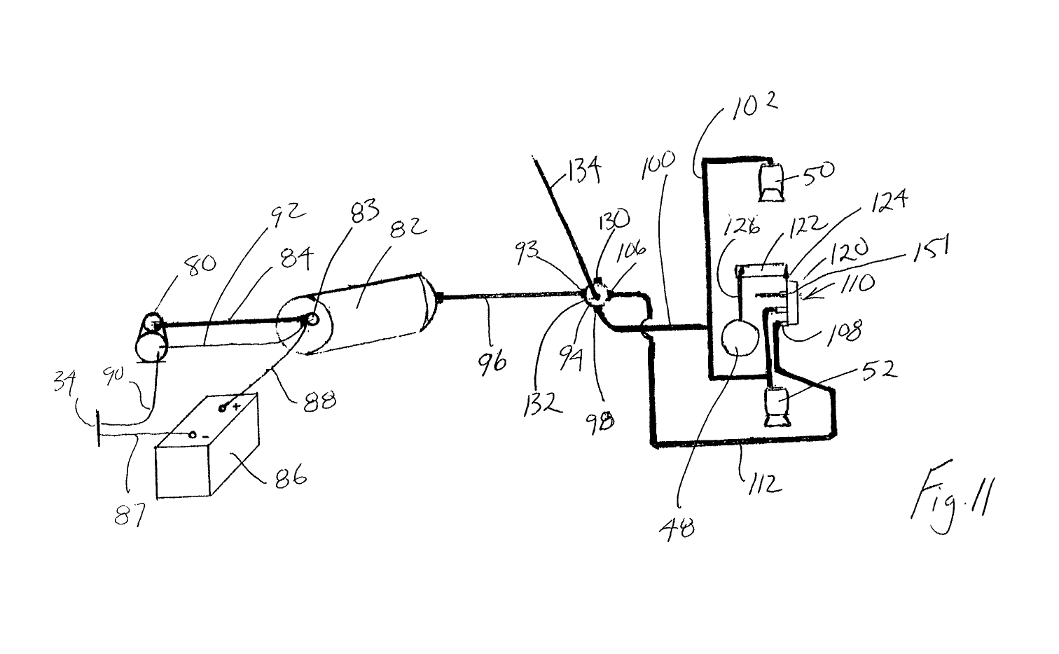

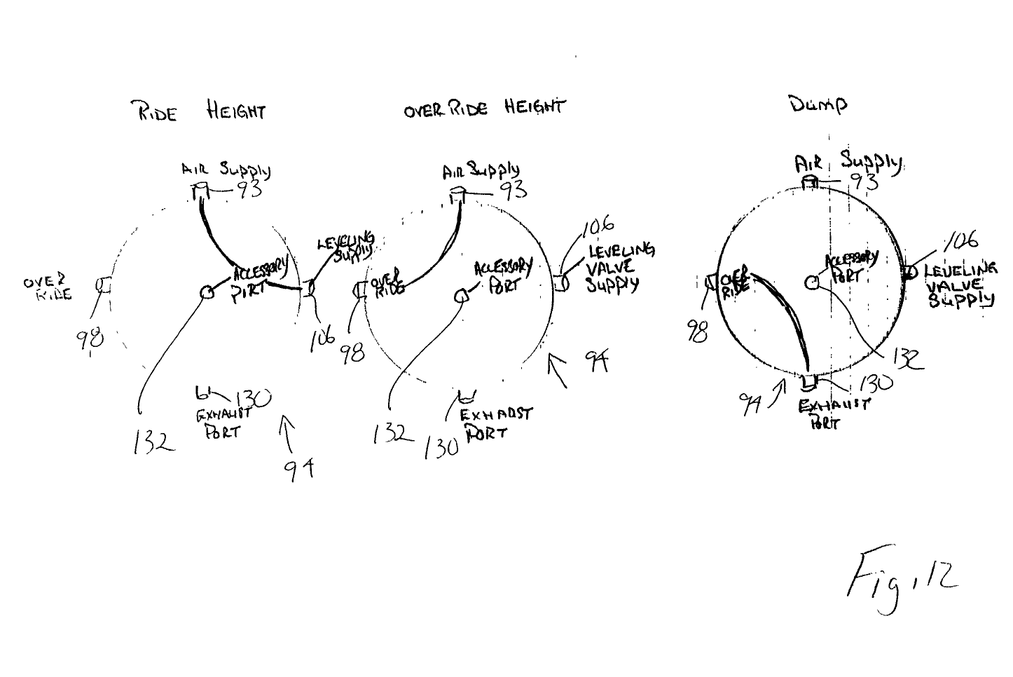

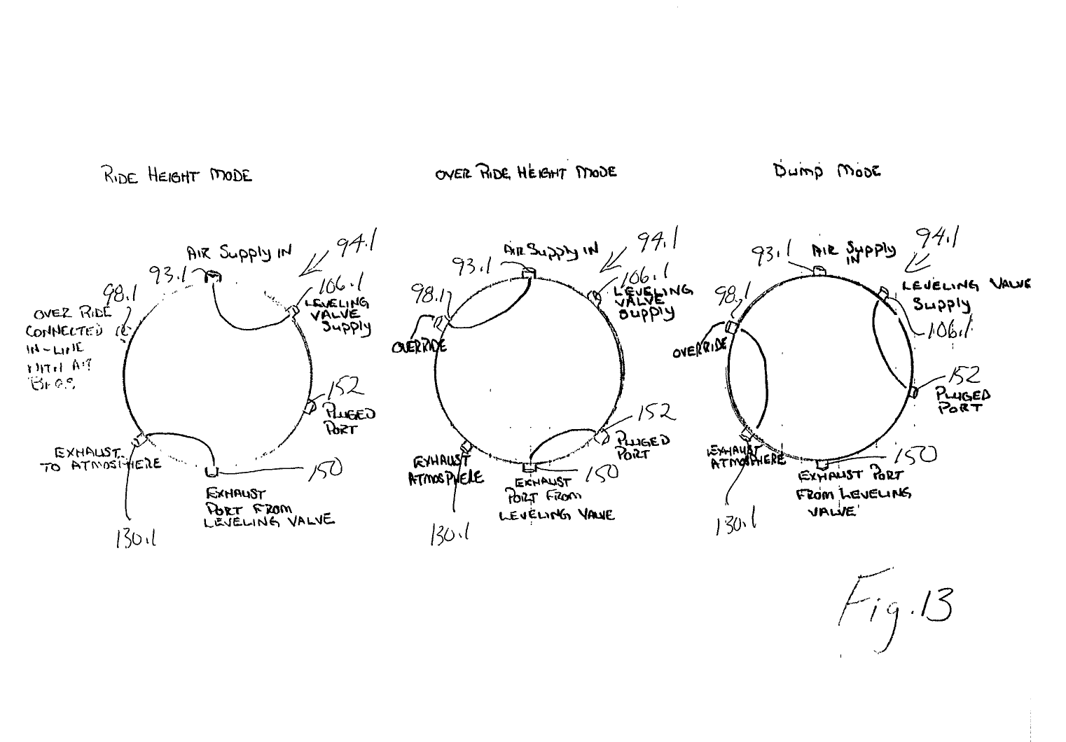

Other variations of the invention are shown in FIG. 5 and FIG. 6. In FIG. 5, where like parts have like numbers with the additional designation “.1”, raised portion 36.1 of frame 34.1 continues to the back end of the trailer. In FIG. 6, where like parts have like numbers with the additional designation “.2”, the frame 34.2 has no raised portion, bracket 41.2 being mounted on the frame. In this instance there is but a single trailing arm 38.2 on each side of the vehicle, a single axle 48.2, which receives a pair of wheels (not shown) and a single air spring 51.2 for each trailing arm.

One of the trailing arms 38 is shown in better detail in FIG. 7, the other trailing arms being identical. Trailing arm 38 has an axle cradle mount 60 and a pivot hole 62 for receiving the pin 44. In this example the trailing arm is of HSS tubing, but other materials could be utilized. The axle seat is of heavy wall pipe. There is a bag mount plate 64 for receiving the air spring 50. Bag mount plate gussets 66 and 68 are connected to the sides of the trailing arm, in this case by welding.

FIG. 8 shows that the bag mount plate 64 is mounted in an offset position as supported by the gussets shown in FIG. 7.

Each of the axles has a depressed center portion 70 which, together with raised portion 36 of the frame shown in FIG. 4, provide clearance for the suspension components including air spring 51 shown in FIG. 10. The center portion 70 is lower than spindle 72 which receives wheel 22. In this example the center portion is an axle beam connected to the spindle by a drop spindle 74.

FIG. 11 shows the components for the pneumatic system of the trailer 20. This includes a compressor 80 connected to air tank 82 by pneumatic line 84. The pump is powered by a battery 86 having a primary wire 88 connected to a pressure switch 83 on the tank and ground 87 connected to frame 34. The compressor has a ground wire 90 connected to the frame and a primary wire 92 connected to the pressure switch on the tank. The pressure switch turns the compressor on and off. In this example the compressor is turned on when air pressure in the air tank falls below 85 psi and shuts off at 105 psi.

The air tank 82 is connected to port 93 of a multiposition valve 94 by pneumatic line 96. The valve has an override port 98 connected in parallel to the air springs by means of pneumatic lines 100 and 102. Likewise the override port is connected to similar air springs for the addition of more axles. The air springs are hooked together in parallel.

The multiposition valve 94 also has a leveling supply port 106 which is connected to port 108 on ride height control valve 110 by means of pneumatic line 112. The valve 110 has a body 120 connected to the frame 34 of the vehicle shown in FIG. 4. There is a lever arm 122 pivotally connected to the body by a pin 124. The lever arm is connected to axle 48 by an adjustable threaded rod 126. There is a similar switch for the other axle.

The multiposition valve 94 also has an exhaust port 130 and an accessory port 132 connected to a pneumatic line 134 to provide air for accessories. FIG. 12 shows the connections between the ports for the different positions of the valve. For ride height adjustment by the ride height control valve 110, air supply port 93 is connected to leveling supply port 106. For override height adjustment, override port 98 is connected to the air supply port. For loading or dumping, the override port 98 is connected to the exhaust port 130 in order to achieve the position of the trailer shown in FIG. 3.

FIG. 13 shows a variation of the valve 94 with six ports. Like parts have like numbers with the additional designation “.1”. The two additional ports are port 150 connected to the exhaust port 151 of the ride height control valve 110, and plugged port 152. As with the previous embodiment, in the ride height mode, the air supply port 93.1 is connected to leveling valve supply port 106.1. The port 150 is connected to port 130.1 to exhaust air from the valve 110. In the override height mode, the port 98.1 is connected to air supply port 93.1 as with the previous embodiment. The port 150 is connected to plugged port 152 which blocks exhaust from the valve 110. In the dump mode, ports 98 and 130 are connected together as before. However in this embodiment the leveling valve supply port 106.1 is connected to plugged port 152 to block air supply to the valve 110.

It will be understood by someone skilled in the art that many of the details provided above are by way of example only and are not intended to limit the scope of the invention which is to be interpreted with reference to the following claims.

What is claimed is:

1. A vehicle trailer having a rear end and an air spring suspension, the trailer comprising:
a body;
an axle;
a pair of wheels mounted on the axle;
a pair of air springs extending operatively between the axle and the body, the air springs having sufficient extensibility to allow the body to be raised or lowered with respect to the wheels and to be tipped downwardly toward the rear end of the trailer to load the trailer.

2. The vehicle trailer as claimed in claim 1, wherein the trailer has two axles, each said axle having a pair of wheels mounted thereon and a pair of air springs extending between each said axle and the body.

3. The vehicle trailer as claimed in claim 2, having an air compressor operatively connected to the air springs.

4. The vehicle trailer as claimed in claim 3, having a pressure sensor connected thereto to turn the compressor on or off to maintain a ride height for the trailer.

5. The vehicle trailer as claimed in claim 4, wherein the pressure sensor has a component connected to the body and a component connected to the axle.

6. The vehicle trailer as claimed in claim 4, wherein the body has a frame, frame having a raised portion adjacent to the axles to provide clearance for the axles.

7. The vehicle trailer as claimed in claim 4, wherein the trailer has a frame, each of the axles having a depressed center portion to provide clearance for the frame.

8. The vehicle trailer as claimed in claim 2, wherein the trailer includes a pair of trailing arms pivotally connected to the body adjacent to each axle, the trailing arms being on opposite sides of the body and the air springs being connected between the trailing arms and the body.

9. The vehicle trailer as claimed in claim 8, having a multiposition valve connected between the compressor and the air springs to control ride height and tipping of the body.
